(19) United States
(12) Patent Application Publication
(10) Pub. No.: US 2015/0003082 A1
(43) Pub. Date: Jan. 1, 2015

(54) LED LAMP RADIATING STRUCTURE

(71) Applicant: Nanqing Zhou, Xiamen City (CN)

(72) Inventor: Nanqing Zhou, Xiamen City (CN)

(73) Assignee: MAINHOUSE (XIAMEN) ELECTRONICS CO., LTD., Xiamen, Fujian (CN)

(21) Appl. No.: 14/005,504

(22) PCT Filed: Aug. 22, 2012
(86) PCT No.: PCT/CN2012/080442

§ 371 Date: Sep. 16, 2013

(30) Foreign Application Priority Data
Feb. 29, 2012 (CN) 201220070894.8

(51) Int. Cl. F21V 29/00; F21K 99/00

(52) U.S. Cl. CPC F21V 29/2212; F21K 9/135; F21K 9/90; F21V 29/2293; F21Y 2101/02
USPC 362/373

(57) ABSTRACT

An LED lamp radiating structure includes a plastic shell and a metal part to serve as heat dissipation bodies. The metal part having a hollow structure is bonded with the plastic shell after the plastic shell is formed by injection molding. A baffle plate is formed on the metal part. An LED chip of the LED lamp is fixed below the baffle plate to contact with the metal part directly. The LED chip is completely contact with the metal part through the baffle plate, and therefore the heat dissipated from the LED chip is conducted to the plastic shell successfully, benefiting the heat dissipation of the LED chip.

### BACKGROUND OF THE INVENTION

1. Field of the Invention

The present invention relates to a lamp, and more particularly to an LED lamp radiating structure.

2. Description of the Prior Art

Compared to a traditional energy-saving lamp, an LED lamp is brighter, consumes less electricity, and has a long service lift so it becomes more and more popular. But, the LED chip generates much heat. It is necessary to have a special heat dissipation structure.

As shown in FIG. 1, FIG. 2 and FIG. 3, an existing lamp comprises a lamp cap 1′, a shell 2′, a metal part 3′, an LED chip 4′, and a lampshade 5′. The circuit parts, such as the circuit board or the like, are installed in the shell 2′. The LED chip 4′ and the metal part 3′ are fixed together. The metal part 3′ provides a heat dissipation effect. In order to lower the cost and achieve a good heat dissipation effect, the shell 2′ is usually made of plastic to bind with the metal part 3′ by injection molding. Thus, the metal part 3′ and the shell 2′ are designed to become a one-piece heat dissipation body. The heat dissipated from the LED chip 4′ is first conducted to the shell 2′ through the metal part 3′, and then dissipated by the shell 2′. The outer side of the shell 2′ may be formed with a plurality of fins to enhance its heat dissipation effect.

However, the circuit board is installed inside the shell 2′ so the metal part 3′ must be a hollow cylinder. For fixing the LED chip 4′, the lower end of the hollow metal part 3′ is provided with an annular flange 31′. In this structure, only the edge of the LED chip 4′ contacts with the heat dissipation material. The heat is dissipated through the edge only. The middle portion is suspended, not contact with the heat dissipation material. The heat dissipation effect is bad so the chip may be damaged with ease. Accordingly, the inventor of the present invention has devoted himself based on his many years of practical experiences to solve this problem.

### SUMMARY OF THE INVENTION

The primary object of the present invention is to provide an LED lamp radiating structure which can make an LED chip contact a heat dissipation material fully to enhance its heat radiation effect.

In order to achieve the aforesaid object, the LED lamp radiating structure of the present invention comprises a plastic shell and a metal part to serve as heat dissipation bodies. The metal part has a hollow structure and is bonded with the plastic shell after the plastic shell is formed by injection molding. The metal part is formed with a baffle plate. An LED chip is fixed below the baffle plate to contact with the metal part directly.

Preferably, the baffle plate of the metal part is disposed at a middle portion inside the metal part, at the bottom of the metal part, or at the top of the metal part.

Preferably, the LED chip is directly fixed below the baffle plate to contact with the baffle plate.

Preferably, the plastic shell is formed with a partition, and the partition is against the top of the baffle plate of the metal part.

Preferably, the metal part is further formed with a chip fixing seat below the baffle plate. The LED chip is fixed on the chip fixing seat to contact with the chip fixing seat directly.

Preferably, the plastic shell is formed with a partition. The baffle plate of the metal part is formed in the partition.

Preferably, the outer side of the plastic shell is formed with fins.

Preferably, the metal part is formed with fins. The fins of the metal part are formed in the fins of the plastic shell.

Preferably, the metal part has a plurality of through holes.

Preferably, the chip fixing seat of the metal part is a hollow structure. The plastic shell comprises a protruding portion formed in a hollow chamber of the chip fixing seat.

The metal part of the present invention is provided with the baffle plate. The LED chip is fixed below the baffle plate to contact with the baffle plate or the chip fixing seat on the baffle plate directly, such that the LED chip can contact with the metal part directly. In this way, the heat dissipated from the LED chip is conducted to the plastic shell successfully, benefiting the heat dissipation of the LED chip.

### BRIEF DESCRIPTION OF THE DRAWINGS

FIG. 1 is an exploded view of a conventional LED lamp;

FIG. 2 is another exploded view of the conventional LED lamp;

FIG. 3 is a sectional view of the conventional LED lamp;

FIG. 4 is an exploded view according to a first embodiment of the present invention;

FIG. 5 is another exploded view according to the first embodiment of the present invention;

FIG. 6 is a sectional view according to the first embodiment of the present invention;

FIG. 7 is an exploded view according to a second embodiment of the present invention;

FIG. 8 is a sectional view according to the second embodiment of the present invention;

FIG. 9 is an exploded view according to a third embodiment of the present invention;

FIG. 10 is a sectional view according to the third embodiment of the present invention.

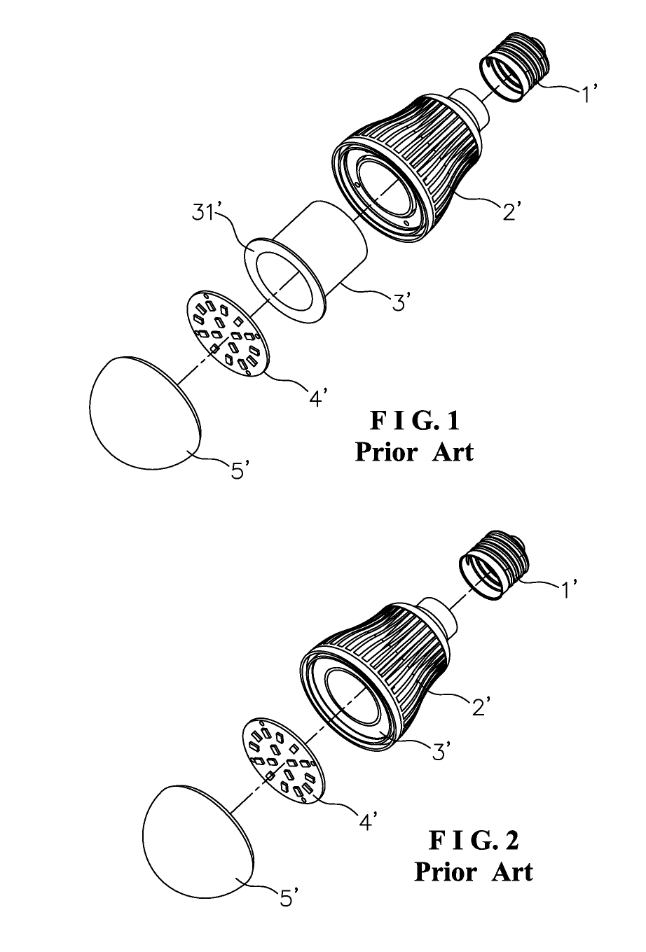

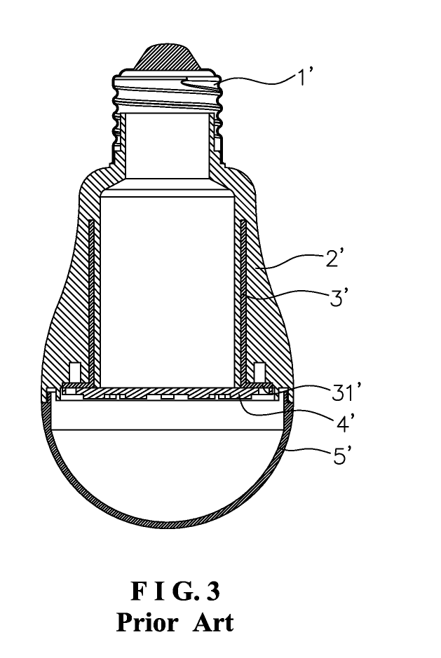

### DETAILED DESCRIPTION OF THE PREFERRED EMBODIMENTS

Embodiments of the present invention will now be described, by way of example only, with reference to the accompanying drawings.

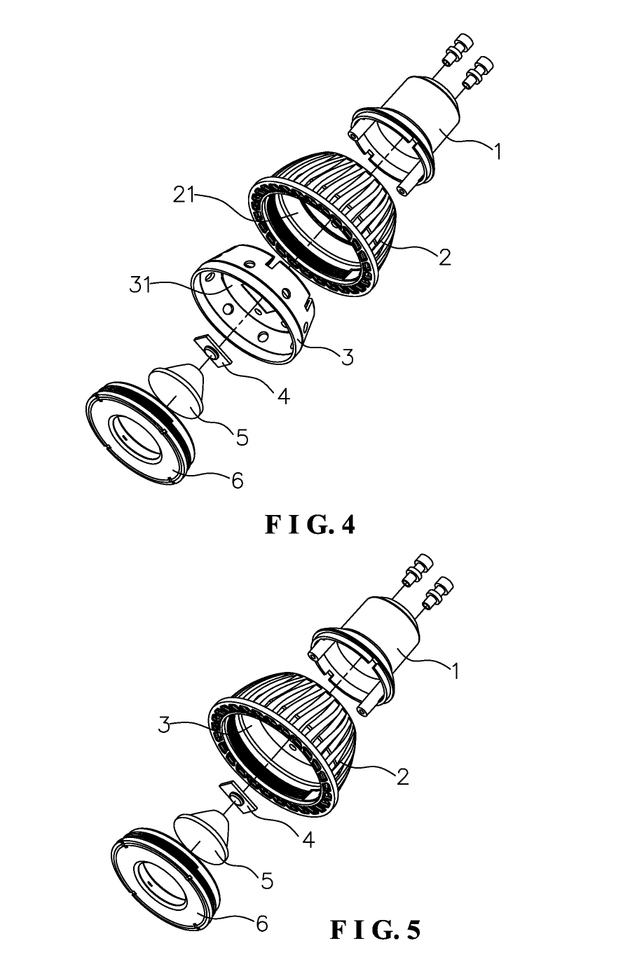

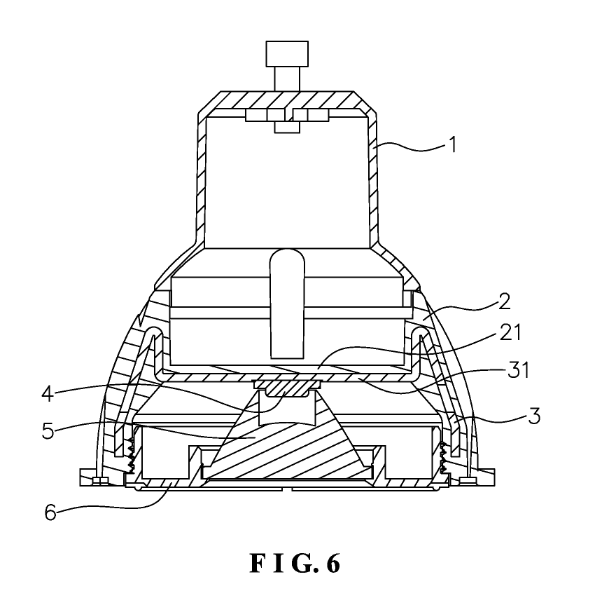

The present invention discloses an LED lamp radiating structure. FIG. 4, FIG. 5 and FIG. 6 show a first embodiment of the present invention. The LED lamp comprises a lamp cap 1, a plastic shell 2, a metal part 3, and an LED chip 4. The circuit parts, such as the circuit board or the like, are installed in the plastic shell 2. For enhancing strength or illumination angle, a lens 5 is provided in front of the LED chip 4. The lens 5 is fixed at the front of the plastic shell 2 through a lens fixing seat 6.

The improvement in the present invention is that the plastic shell 2 and the metal part 3 serve as heat dissipation bodies. The metal part 3 is a hollow structure and bonded with the plastic shell 2 after the plastic shell 2 is formed by injection molding. The metal part 3 is formed with a baffle plate 31. The LED chip 4 is fixed below the baffle plate 31 to contact with the metal part 3 directly. In this embodiment, the LED chip 4 is directly fixed below the baffle plate 31.

The LED chip 4 is completely attached to the metal part 3, such that the heat dissipated from the LED chip 4 is smoothly conducted to the plastic shell 2 through the metal part 3, benefiting the heat dissipation of the LED chip 4.

Furthermore, the baffle plate 31 of the metal part 3 may be disposed at the middle portion inside the metal part 3, so that the plastic shell 2 is formed with an upper chamber and a lower chamber. The upper chamber above the baffle plate 31 is adapted for installing the circuit board, and the lower chamber below the baffle plate 31 is adapted for accommodating the LED chip 4 and the lens 5.

Furthermore, the inner middle of the plastic shell 2 is provided with a partition 21. The partition 21 is against the top of the baffle plate 31 of the metal part 3. When the plastic shell 2 is provided with the partition 21, the heat from the metal part 3 can be conducted to the plastic shell 2 more easily. This benefits the heat dissipation of the chip. Besides, the partition 21 can baffle the heat of the chip, preventing the heat from being conducted to the circuit board on the partition 21 to damage the circuit board because of over heat.

Furthermore, the outer side of the plastic shell 2 is formed with a plurality of fins 22 to enhance the dissipation effect.

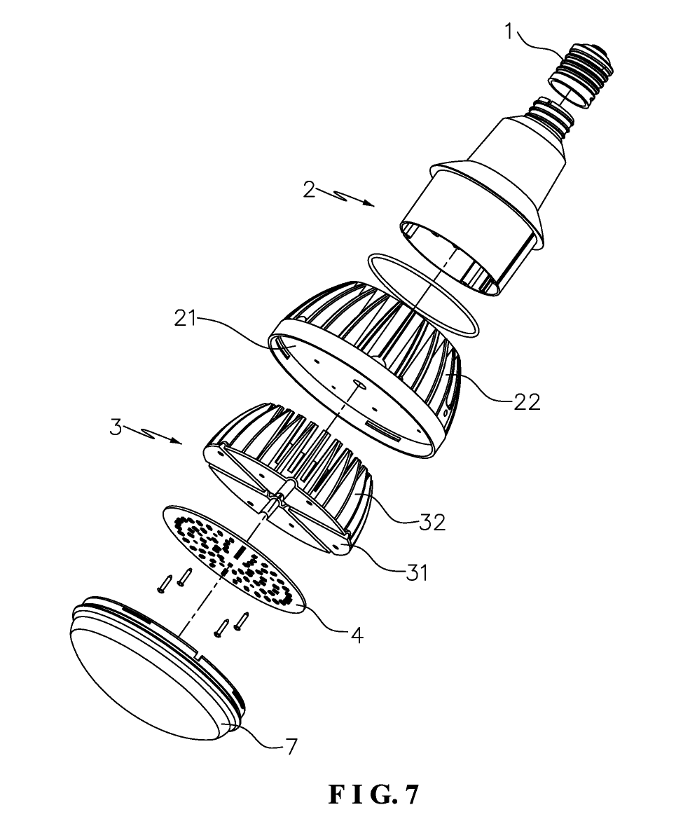

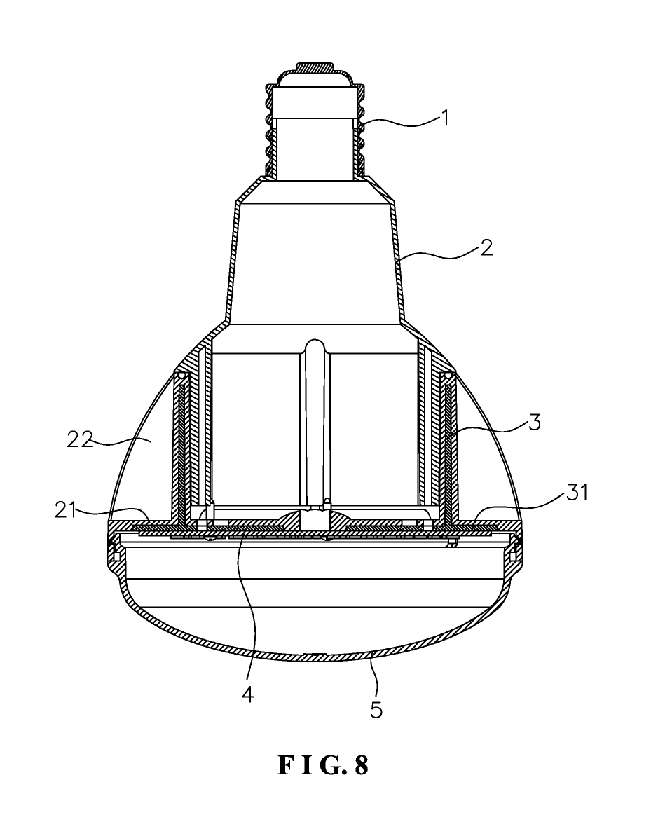

FIG. 7 and FIG. 8 show a second embodiment of the present invention. The LED lamp comprises a lamp cap 1, a plastic shell 2, a metal part 3, and an LED chip 4. In this embodiment, a lampshade 7 is provided in front of the plastic shell 2.

The improvement in the present invention is that the metal part 3 is a hollow structure and bonded with the plastic shell 2 after the plastic shell 2 is formed by injection molding. The metal part 3 is formed with a baffle plate 31. The baffle plate 31 is located at the bottom of the metal part 3. The LED chip 4 is fixed below the baffle plate 31 to contact with the metal part 3 directly.

Furthermore, the plastic shell 2 is formed with a partition 21. The partition 21 is against the top of the baffle plate 31 of the metal part 3 to enhance the heat conduction.

The outer side of the plastic shell 2 is formed with fins 22 to enhance the heat radiation effect. The metal part 3 may be formed with fins 32. The fins 32 are formed in the fins 22.

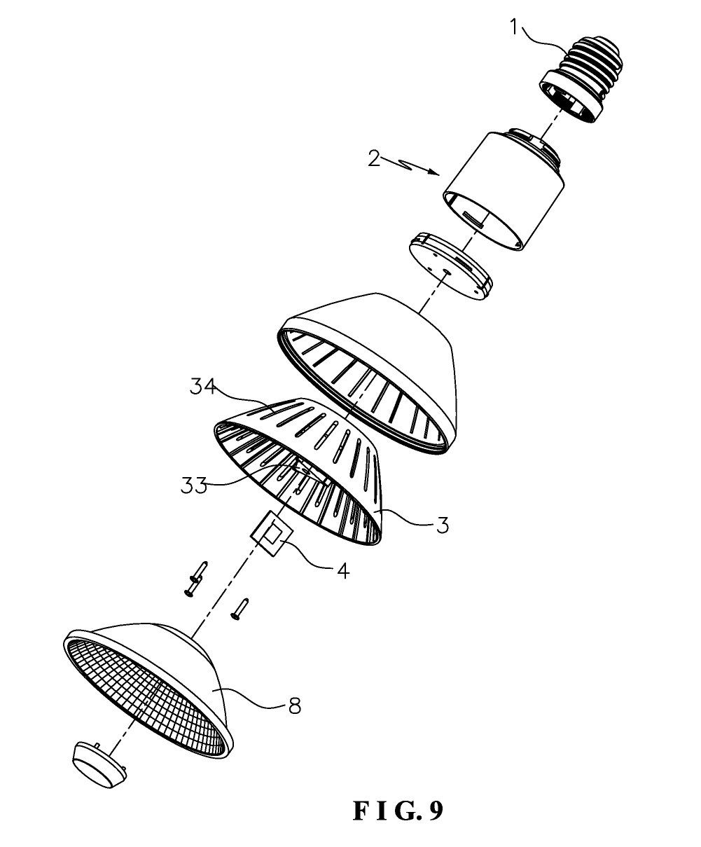

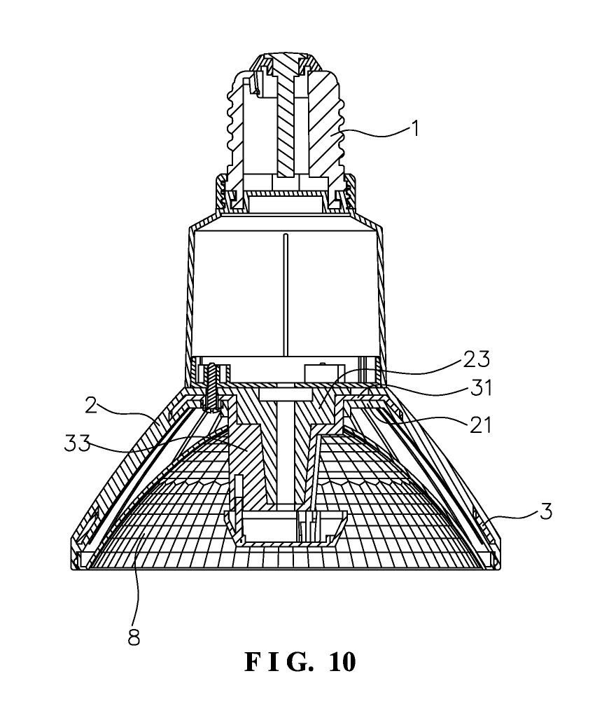

FIG. 9 and FIG. 10 show a third embodiment of the present invention. The LED lamp comprises a lamp cap 1, a plastic shell 2, a metal part 3, and an LED chip 4. In this embodiment, a reflection cup 8 is provided under the plastic shell 2.

The metal part 3 is a hollow structure and bonded with the plastic shell 2 after the plastic shell 2 is formed by injection molding. The metal part 3 is formed with a baffle plate 31. The baffle plate 31 is located at the top of the metal part 3. The LED chip 4 is fixed below the baffle plate 31 to contact with the metal part 3 directly.

In this embodiment, the metal part 3 is further formed with a chip fixing seat 33 below the baffle plate 31. The LED chip 4 is fixed on the chip fixing seat 33 to contact with the chip fixing seat 33 directly.

Furthermore, the plastic shell 2 is formed with a partition 21. The partition 21 is to wrap the baffle plate 31 of the metal part 3 to enhance the heat conduction.

Furthermore, the metal part 3 has a plurality of through holes 34 for connecting with the plastic shell 2 more stably.

The chip fixing seat 33 of the metal part 33 may be a hollow structure to decrease the use of metal so as to lower the cost. The plastic shell 2 comprises a protruding portion 23 formed in the hollow chamber of the chip fixing seat 33 to increase the contact area of the metal part 3 and the plastic shell 2 to enhance the heat radiation effect.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An LED lamp radiating structure, comprising a plastic shell and a metal part to serve as heat dissipation bodies, the metal part having a hollow structure and being bonded with the plastic shell after the plastic shell is formed by injection molding, the metal part being formed with a baffle plate, a LED chip being fixed below the baffle plate to contact with the metal part directly.

2. The LED lamp radiating structure as claimed in claim 1, wherein the baffle plate of the metal part is disposed at a middle portion inside the metal part, at a bottom of the metal part, or at a top of the metal part.

3. The LED lamp radiating structure as claimed in claim 2, wherein the LED chip is directly fixed below the baffle plate to contact with the baffle plate.

4. The LED lamp radiating structure as claimed in claim 3, wherein the plastic shell is formed with a partition, and the partition is against the top of the baffle plate of the metal part.

5. The LED lamp radiating structure as claimed in claim 2, wherein the metal part is further formed with a chip fixing seat below the baffle plate, the LED chip being fixed on the chip fixing seat to contact with the chip fixing seat directly.

6. The LED lamp radiating structure as claimed in claim 5, wherein the plastic shell is formed with a partition, the baffle plate of the metal part being formed in the partition.

7. The LED lamp radiating structure as claimed in one of claims 1-6, wherein an outer side of the plastic shell is formed with fins.

8. The LED lamp radiating structure as claimed in claim 7, wherein the metal part is formed with fins, the fins of the metal part being formed in the fins of the plastic shell.

9. The LED lamp radiating structure as claimed in one of claims 1-6, wherein the metal part has a plurality of through holes.

10. The LED lamp radiating structure as claimed in claim 6, wherein the chip fixing seat of the metal part is a hollow structure, the plastic shell comprising a protruding portion formed in a hollow chamber of the chip fixing seat.
